(19) United States
(12) Patent Application Publication
(10) Pub. No.: US 2010/0018641 A1
(43) Pub. Date: Jan. 28, 2010

(54) Methods of Applying Skin Wellness Agents to a Nonwoven Web Through Electrospinning Nanofibers

(75) Inventors: Kelly Branham, Woodstock, GA (US); Bryan J. Stadelman, Alpharetta, GA (US); Laura Serra, Greenville, WI (US); David W. Koenig, Menasha, WI (US)

Correspondence Address: DORITY & MANNING, P.A., POST OFFICE BOX 1449, GREENVILLE, SC, 29602-1449, US

(73) Assignee: Kimberly-Clark Worldwide, Inc., Neenah, WI (US)

(21) Appl. No.: 11/760,283

(22) Filed: Jun. 8, 2007

(51) Int. Cl. D04H 3/08; D01D 5/06; B29C 65/00

(52) U.S. Cl. 156/244.17; 264/466

(57) ABSTRACT

Generally, the present invention is directed to, in one embodiment, a method for forming a composite nonwoven web configured to deliver skin wellness agents to the skin of a user. According to the method, an aqueous system of a hydrophilic polymer and a skin wellness agent is formed. The aqueous system is then electrospun onto a surface of a nonwoven web containing synthetic fibers. The resulting nanofibers have an average diameter of from about 50 nanometers to about 5000 nanometers, such as from about 200 nanometers to about 700 nanometers.

### BACKGROUND OF THE INVENTION

Webs containing nanofibers have been recently explored due to their high pore volume, high surface area to mass ratio, and other characteristics. These nanofibers have been produced by a variety of methods and from a variety of materials. For example, nanofibers produced from melt fibrillation have been explored. Melt fibrillation generally describes a process of making nanofibers from extruded molten polymers, including melt blowing, melt film fibrillation, and melt fiber bursting. However, the use of the molten polymer to form the nanofibers limits the type of additive that can be included within the resulting nanofiber. For example, many biologically active substances cannot withstand the temperature and other conditions of the melt fibrillation process.

As such, a need currently exists for an improved technique for applying a skin conditioning agent to a nonwoven web such that the agents are more efficiently transferred to the skin of the user.

### SUMMARY OF THE INVENTION

Generally, the present invention is directed to, in one embodiment, a method for forming a composite nonwoven web configured to deliver skin wellness agents. According to the method, an aqueous system of a hydrophilic polymer and a skin wellness agent is formed. The aqueous system is then electrospun onto a surface of a nonwoven web containing synthetic fibers. The resulting nanofibers have an average diameter of from about 50 nanometers to about 5000 nanometers, such as from about 200 nanometers to about 700 nanometers.

In one embodiment, the hydrophilic polymer can be a hydrophilic polyether, such as a polyalkylene oxide. For example, the polyalkylene oxide can have an average molecular weight of about 100,000 g/mol to about 600,000 g/mol, such as from about 200,000 g/mol to about 500,000 g/mol.

Alternatively, the hydrophilic polymer can be a polyvinyl alcohol. In one embodiment, the polyvinyl alcohol is fully hydrolyzed, although partially hydrolyzed (about 80 mole % to about 95 mole %) polyvinyl alcohols may also be utilized.

Other features and aspects of the present invention are discussed in greater detail below.

### BRIEF DESCRIPTION OF THE DRAWINGS

A full and enabling disclosure of the present invention, including the best mode thereof, directed to one of ordinary skill in the art, is set forth more particularly in the remainder of the specification, which makes reference to the appended figures in which:

FIG. 1 illustrates an exemplary nonwoven composite nonwoven web having an exposed nanofiber layer on an outer surface; and

FIG. 2 illustrates an exemplary electrospinning apparatus useful for producing the composite nonwoven webs of the present invention.

### DETAILED DESCRIPTION OF REPRESENTATIVE EMBODIMENTS

### Definitions

As used herein the term “nonwoven fabric or web” means a web having a structure of individual fibers or threads which are interlaid, but not in an identifiable manner as in a knitted fabric. Nonwoven fabrics or webs have been formed from many processes such as for example, meltblowing processes, spunbonding processes, bonded carded web processes, etc.

As used herein, the term “meltblown fibers” refers to fibers formed by extruding a molten thermoplastic material through a plurality of fine, usually circular, die capillaries as molten fibers into converging high velocity gas (e.g. air) streams that attenuate the fibers of molten thermoplastic material to reduce their diameter, which may be to microfiber diameter. Thereafter, the meltblown fibers are carried by the high velocity gas stream and are deposited on a collecting surface to form a web of randomly disbursed meltblown fibers. Such a process is disclosed, for example, in U.S. Pat. No. 3,849,241 to Butin. et al., which is incorporated herein in its entirety by reference thereto for all purposes. Generally speaking, meltblown fibers may be microfibers that may be continuous or discontinuous, are generally smaller than 10 microns in diameter, and are generally tacky when deposited onto a collecting surface.

As used herein, the term “spunbonded fibers” refers to small diameter substantially continuous fibers that are formed by extruding a molten thermoplastic material from a plurality of fine, usually circular, capillaries of a spinnerette with the diameter of the extruded fibers then being rapidly reduced as by, for example, eductive drawing and/or other well-known spunbonding mechanisms. The production of spun-bonded nonwoven webs is described and illustrated, for example, in U.S. Pat. Nos. 4,340,563 to Appel, et al., 3,692,618 to Dorschner. et al., 3,802,817 to Matsuki, et al., 3,338,992 to Kinney, 3,341,394 to Kinney, 3,502,763 to Hartman, 3,502,538 to Petersen, 3,542,615 to Dobo, et al., and 5,382,400 to Pike, et al., which are incorporated herein in their entirety by reference thereto for all purposes. Spunbond fibers are generally not tacky when they are deposited onto a collecting surface. Spunbond fibers can sometimes have diameters less than about 40 microns, and are often between about 5 to about 20 microns.

As used herein, the terms “machine direction” or “MD” generally refers to the direction in which a material is produced. The term “cross-machine direction” or “CD” refers to the direction perpendicular to the machine direction. Dimensions measured in the cross-machine direction are referred to as “width” dimension, while dimensions measured in the machine direction are referred to as “length” dimensions.

As used herein, the term “elastomeric” and “elastic” and refers to a material that, upon application of a stretching force, is stretchable in a direction (such as the MD or CD direction), and which upon release of the stretching force, contracts/returns to approximately its original dimension. For example, a stretched material may have a stretched length that is at least 50% greater than its relaxed unstretched length, and which will recover to within at least 50% of its stretched length upon release of the stretching force. A hypothetical example would be a 2.54-cm sample of a material that is stretchable to at least 3.81 centimeters and which, upon release of the stretching force, will recover to a length of not more than 3.175 centimeters. Desirably, the material contracts or recovers at least 50%, and even more desirably, at least 80% of the stretched length.

As used herein the terms “extensible” or “extensibility” generally refers to a material that stretches or extends in the direction of an applied force by at least about 50% of its relaxed length or width. An extensible material does not necessarily have recovery properties. For example, an elastomeric material is an extensible material having recovery properties. A meltblown web may be extensible, but not have recovery properties, and thus, be an extensible, non-elastic material.

As used herein, the term “percent stretch” refers to the degree to which a material stretches in a given direction when subjected to a certain force. In particular, percent stretch is determined by measuring the increase in length of the material in the stretched dimension, dividing that value by the original dimension of the material, and then multiplying by 100. Such measurements are determined using the “strip elongation test”, which is substantially in accordance with the specifications of ASTM D5035-95. Specifically, the test uses two clamps, each having two jaws with each jaw having a facing in contact with the sample. The clamps hold the material in the same plane, usually vertically, separated by 3 inches (7.62 cm) and move apart at a specified rate of extension. The sample size is 3 inches by 6 inches (7.62 cm×15.24 cm), with a jaw facing height of 1 inch (2.54 cm) and width of 3 inches (7.62 cm), and a constant rate of extension of 300 mm/min. The specimen is clamped in, for example, a Sintech 2/S tester with a Renew MTS mongoose box (control) and using TESTWORKS 4.07b software (Sintech Corp, of Cary, N.C.). The test is conducted under ambient conditions. Results are generally reported as an average of three specimens and may be performed with the specimen in the cross direction (CD) and/or the machine direction (MD).

As used herein, the term “hydrophilic” is intended to describe fibers or the surfaces of fibers which are wetted by the aqueous liquids in contact with the fibers. The degree of wetting of the materials can, in turn, be described in terms of the contact angles and the surface tensions of the liquids and materials involved. Equipment and techniques suitable for measuring the wettability of particular fiber materials or blends of fiber materials can be provided by a Cahn SFA-222 Surface Force Analyzer System, or a substantially equivalent system. When measured with such a system, fibers having contact angles less than 90° are designated “wettable”, while fibers having contact angles equal to or greater than 90° are designated “nonwettable”.

### DETAILED DESCRIPTION

Reference now will be made in detail to various embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention covers such modifications and variations within the scope of the appended claims and their equivalents.

In general, the present invention is directed to methods of electrospinning nanofibers incorporating a skin wellness agent onto an outer surface of a nonwoven web. The electrospun fibers of the present invention have diameters in the nanometer range, and hence provide a very large surface area. This high surface area can dramatically increase the dissolution rate of the polymeric carrier as well as skin wellness agent present in them. By applying the electrospun nanofibers on the outer surface of a nonwoven web, the skin wellness agent can be efficiently delivered to the skin.

### I. Aqueous Polymer System

In accordance with the present invention, nanofibers are electrospun from a aqueous polymer system that contains both a hydrophilic polymeric material and a skin wellness agent. The solution is formed by mixing a hydrophilic polymer and the skin wellness agent in an aqueous solvent. Since the polymer solution contains both the polymeric material and the skin wellness agent at the time of electrospinning, the skin wellness agent is integrated within the polymeric material of the nanofiber.

Through appropriate selection of the polymeric material, the rate of release of the skin wellness agent can be controlled. The polymeric material is generally hydrophilic, such as water-soluble or water-swellable at room temperatures (e.g., from about 20° C. to about 25° C.). Thus, when the nanofibers contact moisture, the polymeric material can swell or dissolve causing the skin wellness agent to be released from the nanofibers. However, controlling the degree of solubility or swellability of the hydrophilic polymer can lead to control of the rate of release of the skin wellness agent. For instance, the more hydrophilic the polymeric material, the quicker the skin wellness agent can be released from the nanofibers upon contact with moisture.

Any suitable hydrophilic polymeric material can be utilized to form the electrospun nanofibers. Examples of such hydrophilic polymers include, for instance, sodium, potassium and calcium alginates, cellulosics, agar, gelatin, polyvinyl alcohol, polyacrylamide, collagen, pectin, chitin, chitosan, poly(α-amino acids), polyvinylpyrrolidone, hydrophilic polyether, polysaccharide, hydrophilic polyurethane, polyhydroxyethylacrylate, polymethacrylate, dextran, natural gums, and homopolymers and copolymers of N-vinylpyrrolidone, N-vinyllactam, N-vinyl butyrolactam, N-vinyl caprolactam, other vinyl compounds having polar pendant groups, acrylate and methacrylate having hydrophilic esterifying groups, acrylamide, hydroxyethylacrylate, acrylic acid, and derivatives and combinations thereof. Cellulosics include, but are not limited to, methyl cellulose, ethyl cellulose, hydroxypropyl cellulose, carboxymethyl cellulose, hydroxypropyl methyl cellulose, hydroxyethyl methyl cellulose, hydroxyethyl cellulose, and the like. Natural gums include, but are not limited to, xanthan gum, guar gum, pectin, gum Arabic, locust bean gum, carrageenan gum, and the like. Two particular examples of suitable hydrophilic polymeric materials are hydrophilic polyethers, polyvinyl alcohols, and their derivatives. Of course, any combination of suitable hydrophilic polymers, such as those listed above, may be included within the aqueous polymeric system.

Hydrophilic polyethers can include, but are not limited to, polyalkylene oxides (e.g., polyalkylene glycols) and their derivatives. Polyethylene oxide (PEO) and polypropylene oxide (PPO) are examples of suitable polyalkylene oxides. When utilized, the polyalkylene oxide may have on average about 30 to about 15,000 oxide units (e.g., glycol units) per polymeric molecule. Generally, to form the electrospun nanofibers, the polyalkylene oxide can have an average molecular weight (g/mol) of about 100,000 to about 600,000, such as from about 200,000 to about 500,000. In one particular embodiment, the polyalkylene oxide has a weight average molecular weight of about 250,000 to about 400,000, such as about 300,000. Controlling the average molecular weight of the polyalkylene oxide can control the solubility of the polymer. Generally, longer polymeric chains (i.e., higher average molecular weight) result in less soluble polymers.

Alternatively, or additionally, the polymeric material can include polyvinyl alcohol (PVOH). Polyvinyl alcohol is a synthetic polymer that may be formed, for instance, by replacing acetate groups in polyvinyl acetate with hydroxyl groups according to a hydrolysis reaction. The basic properties of polyvinyl alcohol depend on its degree of polymerization, degree of hydrolysis, and distribution of hydroxyl groups. In terms of the degree of hydrolysis, polyvinyl alcohol may be produced so as to be fully hydrolyzed (e.g., greater than about 99% hydrolyzed) or partially hydrolyzed. By being partially hydrolyzed, the polyvinyl alcohol may contain vinyl acetate units.

The water solubility of polyvinyl alcohol depends primarily on its degree of polymerization and degree of hydrolysis. Of the two factors, the degree of hydrolysis has more of an effect on water solubility. For instance, the presence of small amounts of residual acetate units (such as little as 2-3 mole percent) causes a significant change in the solubility of the polymer.

Thus, a skilled artisan can control the rate of release of the skin wellness agents by controlling the degree of hydrolysis of the polyvinyl alcohol used to form the nanofibers. In one embodiment, the water soluble fibers are made from polyvinyl alcohol that is less than 95% hydrolyzed, such as less than about 90% hydrolyzed. For many applications, the polyvinyl alcohol can be hydrolyzed by at least 80%. For example, in one embodiment, the polyvinyl alcohol may be hydrolyzed in an amount of from about 80% to about 95%. In one particular embodiment, the polyvinyl alcohol may be hydrolyzed in an amount of from about 85% to about 90%, so that the polymer is readily soluble in water at room temperature. As used herein, the above percentages are based upon a mole percent.

In addition to controlling the amount of hydrolysis, polyvinyl alcohol fibers may also be made water soluble by other means. For instance, it is also possible to obtain a fiber soluble in water at lower temperatures by using a polyvinyl alcohol polymer containing units other than those from vinyl alcohol or vinyl acetate. In particular, the polyvinyl alcohol polymer may be chemically modified by incorporating into the polymer various monomers. The monomers may be present, for instance, in an amount of less than about 5 mole percent, such as from about 0.1 mole percent to about 2 mole percent. Examples of monomers that may be incorporated into a polyvinyl alcohol polymer for increasing the water solubility of the polymer include ethylene, allyl alcohol, itaconic acid, acrylic acid, maleic anhydride, arylsulfonic acid, and vinyl esters of aliphatic acids having at least four carbon atoms such as vinyl pivalate, vinyl pyrrolidone and compounds obtained by neutralizing part or all of the above ionic groups. The monomers may be introduced into the polymer by copolymerization or by post-reaction, and may be distributed in the resulting polymer chain in random, block-wise or grafted form with no specific limitation.

No matter the hydrophilic polymeric material selected to form the electrospun nanofibers, a skin wellness agent is also incorporated into the nanofibers. Generally, the skin wellness agent is present in an amount sufficient to provide a benefit to the skin of a user. Thus, depending on the particular skin wellness agent utilized, the actual amount present in the aqueous polymeric system may vary. For example, in some embodiments, the skin wellness agent can be present in an amount of less than about 10% by weight of the aqueous polymeric system, such as from about 0.001% to about 5% by weight. In other embodiments, however, a greater amount of the skin wellness agent may be present, such as from about 10% by weight to about 50% by weight.

The skin wellness agent can be any material that provides a benefit to the skin of a user and can be incorporated into the aqueous polymer system and subsequently electrospun to form nanofibers. For example, the skin wellness agent can include moisturizers, skin smothers, exfoliation agents, collagen synthesis agents, barrier enhancers, anti-inflamatory agents, film-forming/skin tightening agents, anti-acne agents, vitamins, antibiotics, sunscreens, skin protectants, anti-wrinkle agents, etc.

In order to be co-electrospun with the hydrophilic polymer to form the nanofibers, the skin wellness agents are generally hydrophilic, or at least water-dispersible agents as long as the skin wellness agent is capable of being added to the aqueous polymeric system and electrospun with the hydrophilic polymeric material. However, the present inventors have found that it is also possible to co-electrospin oil soluble agents, even if they are non-water soluble, within the nanofibers. For example, the skin wellness agent can be dispersed, suspended, or otherwise emulsified within the aqueous polymeric system, while still enabling nanofibers to be electrospun from the solution.

Skin moisturizers can include, but are not limited to glycerin, hyaluronic acid (e.g., FLUKA 53747 available from Sigma-Aldrich, Inc., St. Louis), collagen (e.g., those available from Pentapharm, LTD., Switzerland), and amino acid derivatives (e.g., those available under the name TEGO Cosmo from Centerchem, Inc., Norwalk, Conn.). Skin smothers, exfoliation agents, and/or collagen synthesis agents can include, but are not limited to, vitamin A (such as RetiSTAR available from BASF) and lactic acid (such as AH-CARE L-65 available from Cognis Corp., Cincinnati). Barrier enhancers can include, but are not limited to, a ceramide and lipid mix (such as SK-influx available from Centerchem, Inc., Norwalk, Conn., as a distributor for Degussa) and dimethicone (such as ABIL 350 available from Centerchem, Inc., Norwalk, Conn., as a distributor for Degussa). Antioxidants can include, but are not limited to, vitamin C, vitamin E, and polyphenols (such as ARGANYL LS 9781 available from Cognis Corp., Cincinnati). Anti-inflammatory agents can include, but are not limited to, natural bisabolol, herbalia green tea (available from Cognis Corp., Cincinnati), and bentonite clay. Film forming/skin tightening agents can include, but are not limited to, peptides, such as Eyeseryl available from Lipotec), and the hydrolyzed wheat gluten and ceratonia siliqua gum mix available from Pentapharm, LTD., Switzerland under the name Pentacare NA.

Of course, any other skin wellness agents can be utilized according to the present invention. Likewise, any combination of skin wellness agents can be utilized within a particular aqueous polymer system to form the nanofibers.

No matter the particular skin wellness agent(s) utilized, the skin wellness agent(s) is incorporated into the aqueous polymer system along with the polymeric material. Thus, upon electrospinning of the resulting nanofibers from the aqueous polymer system, the skin wellness agents can be incorporated within the structure of the nanofibers. As a result, upon contact with moisture, the polymeric material dissolves or swells, allowing the skin wellness agent(s) to be released from the fibers. For example, moisture present on the skin of a user can sufficiently cause the skin wellness agent(s) to be released from the nanofibers.

Generally, the skin wellness agent can be incorporated into the aqueous polymeric system in any effective amount up to about 50% by weight. However, less amounts of the skin wellness agent can be included in the aqueous polymeric system, such as from about 0.1% to about 30% by weight, and particularly from about 0.5% to about 20% by weight, and more particularly about 1% to about 10% by weight. However, in some embodiments, the use of lower amounts of the skin wellness agent may provide the same benefits to the user, while reducing materials cost and avoiding unnecessary waste of excess materials.

Since the electrospinning process can be performed at room temperatures with aqueous systems, relatively volatile or thermally unstable skin wellness agents can be included within the nanofibers.

The polymeric material and the skin wellness agent(s) are combined with a solvent to form the aqueous polymer system. Although the solution is referred to as an aqueous system, the solvent is not limited to water. In fact, other polar solvents and solvent systems can be utilized. For example, the solvent and/or solvent system can include, but are not limited to, water, acetic acid, acetone, acetonitrile, alcohol (e.g., methanol, ethanol, propanol, isopropanol, butanol, and the like), alkyl acetate (e.g., ethyl acetate, propyl acetate, butyl acetate, etc.), polyethylene glycols, propylene glycol, butylene glycol, ethoxydiglycol, hexylene glycol, methyl ethyl ketone, or mixtures thereof.

Other ingredients may also be included within the aqueous polymer system to affect the resulting electrospun nanofibers. Parameters affecting electrospinning are viscosity, surface tension, and electrical conductivity of the solvent polymeric composition. For example, increasing the polymer concentration leads to an increased viscosity of the solution and vice versa. The same is true, in general, in the case of a dispersion of an insoluble active agent (adjuvant or mobile additive); as the concentration of the dispersant increases the viscosity of the dispersion increases. Depending on processing or end use requirements, a skilled artisan may employ any or combinations of the following additives: viscosity modifiers, surfactants, plasticizers, etc.

### II. Electrospinning

Electrospinning, also known as electrostatic spinning, is a process of producing fibers, with diameters of less than a few microns. For example, the electrospun nanofibers can have an average diameter of less than about 5 microns, such as less than about 1 micron. Conversely, the electospun nanofibers generally have an average diameter of greater than about 50 nanometers, such as greater than about 200 nanometers. Thus, typical electrospun nanofibers can have an average diameter of between about 50 nanometers and about 5 microns, such as from about 200 nanometers to about 1 micron. In some embodiments, the average diameter of the electrospun nanofibers can be from about 200 nanometers to about 700 nanometers.

The electrospinning process generally involves applying a high voltage (e.g., about 3 kV to about 80 kV, depending on the configuration of the electrospinning apparatus) to a polymer solution to produce a polymer jet. As the jet travels in air, the jet is elongated under repulsive electrostatic force to produce nanofibers from the polymer solution. The homogenous nature of the process allows for the skin wellness agent to be substantially homogenously dispersed throughout the polymeric material of the nanofibers.

The high voltage is applied between the grounded surface (or oppositely charged surface) and a conducting capillary into which a polymer solution is injected. The high voltage can also be applied to the solution or melt through a wire if the capillary is a nonconductor such as a glass pipette. Initially the solution at the open tip of the capillary is pulled into a conical shape (the so-called “Taylor cone”) through the interplay of electrical force and surface tension. At a certain voltage range, a fine jet of polymer solution forms at the tip of the Taylor cone and shoots toward the target. Forces from the electric field accelerate and stretch the jet. This stretching, together with evaporation of solvent molecules, causes the jet diameter to become smaller. As the jet diameter decreases, the charge density increases until electrostatic forces within the polymer overcome the cohesive forces holding the jet together (e.g., surface tension), causing the jet to split or “splay” into a multifilament of polymer nanofibers. The fibers continue to splay until they reach the collector, where they are collected as nonwoven nanofibers, and are optionally dried.

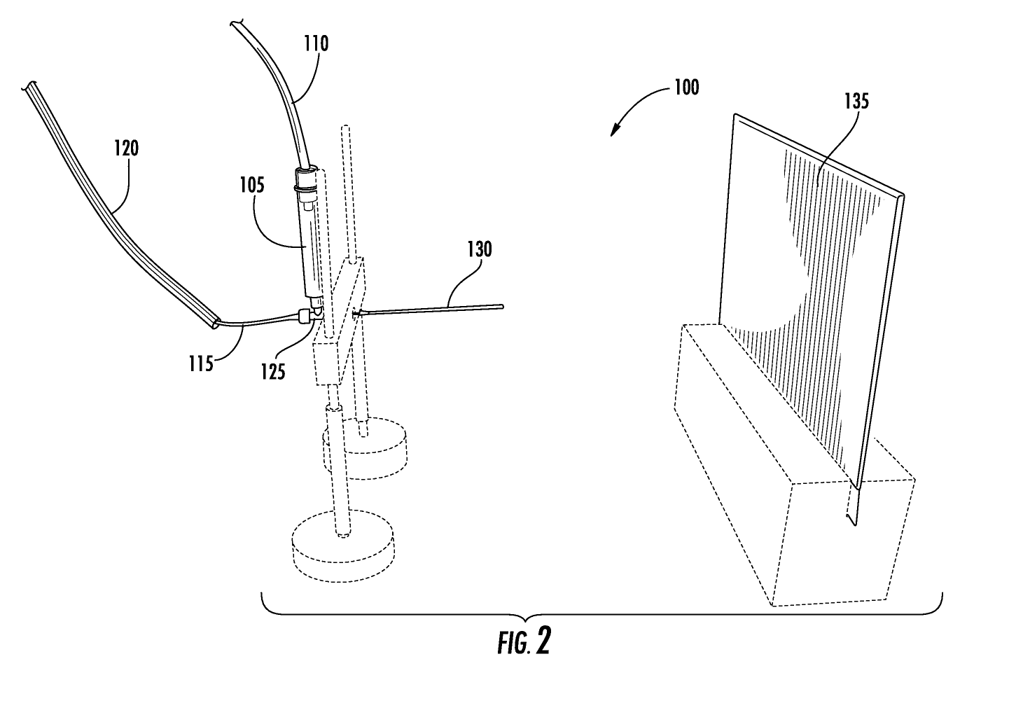

For example, referring to FIG. 2, an exemplary electrospinning apparatus 100 is generally represented. The aqueous polymer system is provided through the solution reservoir 105, which is pressurized by the air pressure source 110. Optionally, a solution source tube (not shown) can supply a continuous amount of the aqueous polymer system to the solution reservoir 105. The high voltage source (positive polarity) is supplied via the electrode 115 (e.g., tungsten), which is shown encased within an optional protective tube 120. The electrode 115 and the solution reservoir are connected at joint 125 to apply the voltage to the aqueous polymer system. Once the voltage is applied to the aqueous polymer system, the aqueous polymer system is forced into the micropipette 130 positioned between the positive polarity voltage source and the grounded or negatively biased collecting plate 135.

Accordingly, the nanofibers can be electrospun directly on the nonwoven web facing by positioning the nonwoven web between the micropipette 130 and the grounded or negatively biased collecting plate 135, causing the nanofibers to be collected on the surface of the nonwoven web facing.

### III. Nonwoven Webs

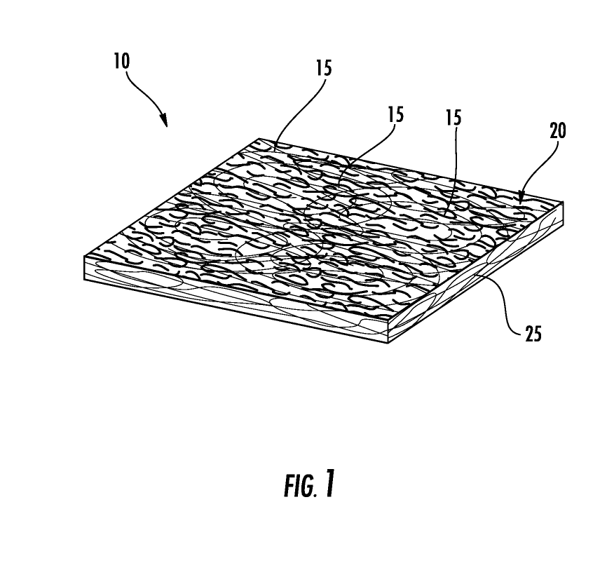

As discussed above, the electrospun nanofibers are spun directly on a surface of a nonwoven web. For instance, referring to FIG. 1, a composite nonwoven web 10 is shown having nanofibers 15 positioned on an outer surface 20 of the nonwoven web 25. Thus, when the composite nonwoven web 10 contacts moisture, the nanofibers 15 can release the skin wellness agent onto the skin of a user. Although the electrospun nanofibers 15 are shown as discontinuous fibers, the nanofibers 15 can have any length desired, and may be continuously electrospun.

The percent add-on of the electrospun nanofibers will depend on several factors, such as the weight and thickness of the electrospun nanofiber layer, the weight of the nonwoven web or laminate. Thus, the percent add-on of the electrospun nanofibers, and subsequently the percent add-on of the skin wellness agent, can be controlled by varying one of these factors. Typically, the electrospun nanofiber layer can have a thickness on the surface of the nonwoven web of up to about a millimeter, such as from about 100 nanometers (e.g., only one nanofiber) to 500 microns (several layers of nanofibers). In one particular embodiment, however, the thickness of the electrospun nanofiber layer is from about 500 nanometers to about 100 microns on the surface of the web, which generally provides enough skin wellness agent to benefit the user without creating excessive materials costs.

Varying the thickness of the electrospun nanofiber layer controls the add-on of the electrospun nanofibers on the surface of the nonwoven laminate. In most embodiments, the add-on for the electrospun nanofibers can be up to about 0.1 mg/cm² in order to provide sufficient benefits to the skin of the user while still minimizing excess use of the skin wellness agents. For example, the electrospun nanofibers can be at an add-on level of up to about 2 gsm, such as from about 0.1 gsm to about 1 gsm.

Accordingly, the add-on of the skin wellness agent to the nonwoven laminate can vary with add-on of the electrospun nanofibers and the concentration of the skin wellness agent in the aqueous polymeric system. For example, the add-on of the skin wellness agent can be up to about 500 μg/cm², such as from about 0.01 μg/cm² to about 100 μg/cm². In some particular embodiments, the add-on of the skin wellness agent can be from about 0.1 μg/cm² to about 50 μg/cm², such as from about 0.05 μg/cm² to about 0.25 μg/cm².

The nonwoven web facing can be any suitable nonwoven web. In particular, the nonwoven web is constructed from polymeric fibers, such as synthetic fibers. Synthetic fibers can provide strength to the resulting composite nonwoven web, such that the integrity of the nonwoven web is not compromised when contacting moisture. Thus, the composite nonwoven web can contact moisture, or even be immersed in water, allowing the skin wellness agents to be released from the nanofibers but not substantially damaging the underlying nonwoven web.

Exemplary synthetic polymers for use in forming nonwoven web may include, for instance, polyolefins, e.g., polyethylene, polypropylene, polybutylene, etc.; polytetrafluoroethylene; polyesters, e.g., polyethylene terephthalate and so forth; polyvinyl acetate; polyvinyl chloride acetate; polyvinyl butyral; acrylic resins, e.g., polyacrylate, polymethylacrylate, polymethylmethacrylate, and so forth; polyamides, e.g., nylon; polyvinyl chloride; polyvinylidene chloride; polystyrene; polyvinyl alcohol; polyurethanes; polylactic acid; copolymers thereof; and so forth. If desired, biodegradable polymers, such as those described above, may also be employed. It should be noted that the polymer(s) may also contain other additives, such as processing aids or treatment compositions to impart desired properties to the fibers, residual amounts of solvents, pigments or colorants, and so forth.

Monocomponent and/or multicomponent fibers may be used to form the nonwoven web. Monocomponent fibers are generally formed from a polymer or blend of polymers extruded from a single extruder. Multicomponent fibers are generally formed from two or more polymers (e.g., bicomponent fibers) extruded from separate extruders. The polymers may be arranged in substantially constantly positioned distinct zones across the cross-section of the fibers. The components may be arranged in any desired configuration, such as sheath-core, side-by-side, pie, island-in-the-sea, three island, bull's eye, or various other arrangements known in the art. Various methods for forming multicomponent fibers are described in U.S. Pat. Nos. 4,789,592 to Taniguchi et al. and U.S. Pat. No. 5,336,552 to Strack, et al., 5,108,820 to Kaneko, et al., 4,795,668 to Kruege, et al., 5,382,400 to Pike, et al., 5,336,552 to Strack, et al., and 6,200,669 to Marmon, et al., which are incorporated herein in their entirety by reference thereto for all purposes. Multicomponent fibers having various irregular shapes may also be formed, such as described in U.S. Pat. Nos. 5,277,976 to Hogle, et al., 5,162,074 to Hills 5,466,410 to Hills, 5,069,970 to Largman, et al., and 5,057,368 to Largman, et al., which are incorporated herein in their entirety by reference thereto for all purposes.

Although any combination of polymers may be used, the polymers of the multicomponent fibers are typically made from thermoplastic materials with different glass transition or melting temperatures where a first component (e.g., sheath) melts at a temperature lower than a second component (e.g., core). Softening or melting of the first polymer component of the multicomponent fiber allows the multicomponent fibers to form a tacky skeletal structure, which upon cooling, stabilizes the fibrous structure. For example, the multicomponent fibers may have from about 5% to about 80%, and in some embodiments, from about 10% to about 60% by weight of the low melting polymer. Further, the multicomponent fibers may have from about 95% to about 20%, and in some embodiments, from about 90% to about 40%, by weight of the high melting polymer. Some examples of known sheath-core bicomponent fibers available from KoSa Inc. of Charlotte, N.C. under the designations T-255 and T-256, both of which use a polyolefin sheath, or T-254, which has a low melt co-polyester sheath. Still other known bicomponent fibers that may be used include those available from the Chisso Corporation of Moriyama, Japan or Fibervisions LLC of Wilmington, Del.

Fibers of any desired length may be employed, such as staple fibers, continuous fibers, etc. In one particular embodiment, for example, staple fibers may be used that have a fiber length in the range of from about 1 to about 150 millimeters, in some embodiments from about 5 to about 50 millimeters, in some embodiments from about 10 to about 40 millimeters, and in some embodiments, from about 10 to about 25 millimeters. Although not required, carding techniques may be employed to form fibrous layers with staple fibers as is well known in the art. For example, fibers may be formed into a carded web by placing bales of the fibers into a picker that separates the fibers. Next, the fibers are sent through a combing or carding unit that further breaks apart and aligns the fibers in the machine direction so as to form a machine direction-oriented fibrous nonwoven web. The carded web may then be bonded using known techniques to form a bonded carded nonwoven web.

If desired, the nonwoven web may have a multi-layer structure. The other layers can be other nonwoven webs, films, and the like. For example, in one embodiment, at least two nonwoven webs can be combined to form a nonwoven laminate. In most embodiments, the nanofibers are applied to an outer surface of the nonwoven laminate to facilitate delivery of the skin wellness agent to the skin of the user. Suitable multi-layered materials may include, for instance, spunbond/meltblown/spunbond (SMS) laminates and spunbond/meltblown (SM) laminates. Various examples of suitable SMS laminates are described in U.S. Pat. Nos. 4,041,203 to Brock et al.; 5,213,881 to Timmons, et al.; 5,464,688 to Timmons, et al.; 4,374,888 to Bornslaeger; 5,169,706 to Collier, et al.; and 4,766,029 to Brock et al., which are incorporated herein in their entirety by reference thereto for all purposes. In addition, commercially available SMS laminates may be obtained from Kimberly-Clark Corporation under the designations Spunguard® and Evolution®.

Another example of a multi-layered structure is a spunbond web produced on a multiple spin bank machine in which a spin bank deposits fibers over a layer of fibers deposited from a previous spin bank. Such an individual spunbond nonwoven web may also be thought of as a multi-layered structure. In this situation, the various layers of deposited fibers in the nonwoven web may be the same, or they may be different in basis weight and/or in terms of the composition, type, size, level of crimp, and/or shape of the fibers produced. As another example, a single nonwoven web may be provided as two or more individually produced layers of a spunbond web, a carded web, etc., which have been bonded together to form the nonwoven web. These individually produced layers may differ in terms of production method, basis weight, composition, and fibers as discussed above.

In addition to synthetic fibers, the nonwoven web may also contain an additional fibrous component such that it is considered a composite. For example, a nonwoven web may be entangled with another fibrous component using any of a variety of entanglement techniques known in the art (e.g., hydraulic, air, mechanical, etc.). In one embodiment, the nonwoven web is integrally entangled with cellulosic fibers using hydraulic entanglement. Hydraulically entangled nonwoven webs of staple length and continuous fibers are disclosed, for example, in U.S. Pat. Nos. 3,494,821 to Evans and 4,144,370 to Boulton, which are incorporated herein in their entirety by reference thereto for all purposes. Hydraulically entangled composite nonwoven webs of a continuous fiber nonwoven web and a pulp layer are disclosed, for example, in U.S. Pat. Nos. 5,284,703 to Everhart, et al. and 6,315,864 to Anderson, et al., which are incorporated herein in their entirety by reference thereto for all purposes.

In yet another multi-layered structure, the nonwoven web can be used as a facing on to form an elastic laminate. For example, the nanofibers may be electrospun on various elastic laminates in accordance with the present invention, provided that the elastic laminate has at least one nonwoven web facing laminated to an elastic material. Regardless of the material selected, the laminate is “stretchable”, i.e., upon application of a force, the laminate may be stretched to a biased length that is at least about 125%, and in some embodiments, at least about 150% its unstretched length. Additionally, the elastic laminate will also recover at least about 50% of its elongation upon release of the stretching, biasing force.

Generally speaking, the nonwoven web facing may be laminated to the elastic material to reduce the coefficient of friction and enhance the cloth-like feel of its surface. The basis weight of the nonwoven web facing may generally vary, such as from about 5 grams per square meter (“gsm”) to 120 gsm, in some embodiments from about 8 gsm to about 70 gsm, and in some embodiments, from about 10 gsm to about 35 gsm.

The elastic material may be a film, foam, strands, elastic nonwoven web, and so forth. In one embodiment, the elastic material includes a film. Any known technique may be used to form a film, including blowing, casting, flat die extruding, etc. Although not required, the film may be stretched to improve its properties. For example, the film may be drawn by rolls rotating at different speeds of rotation so that the sheet is stretched to the desired draw ratio in the longitudinal direction (machine direction). In addition, the uniaxially stretched film may also be oriented in the cross-machine direction to form a “biaxially stretched” film. Various parameters of a stretching operation may be selectively controlled, including the draw ratio, stretching temperature, and so forth. In some embodiments, for example, the film is stretched in the machine direction at a stretch ratio of from about 1.5 to about 7.0, in some embodiments from about 1.8 to about 5.0, and in some embodiments, from about 2.0 to about 4.5. The stretch ratio may be determined by dividing the length of the stretched film by its length before stretching. The stretch ratio may also be approximately the same as the draw ratio, which may be determined by dividing the linear speed of the film upon stretching (e.g., speed of the nip rolls) by the linear speed at which the film is formed (e.g., speed of casting rolls or blown nip rolls). The film may be stretched at a temperature from about 15° C. to about 50° C., in some embodiments from about 25° C. to about 40° C., and in some embodiments, from about 30° C. to about 40° C. Preferably, the film is “cold drawn”, i.e., stretched without the application of external heat (e.g., heated rolls).

The film may be a mono- or multi-layered film. Multilayer films may be prepared by co-extrusion of the layers, extrusion coating, or by any conventional layering process. Such multilayer films normally contain a base layer and skin layer, but may contain any number of layers desired. For example, the multilayer film may be formed from a base layer and one or more skin layers, wherein the base layer is formed from a block copolymer in accordance with the present invention. In such embodiments, the skin layer(s) may be formed from any film-forming polymer. If desired, the skin layer(s) may contain a softer, lower melting polymer or polymer blend that renders the layer(s) more suitable as heat seal bonding layers for thermally bonding the film to a nonwoven web facing. In most embodiments, the skin layer(s) are formed from an olefin polymer. Additional film-forming polymers that may be suitable for use with the present invention, alone or in combination with other polymers, include ethylene vinyl acetate, ethylene ethyl acrylate, ethylene acrylic acid, ethylene methyl acrylate, ethylene normal butyl acrylate, nylon, ethylene vinyl alcohol, polystyrene, polyurethane, and so forth.

In another embodiment of the present invention, the elastic material includes a plurality of strands. The number of strands may vary as desired, such as from 5 to about 20, in some embodiments from about 7 to about 18, and in some embodiments, from about 8 to 15 strands per cross-directional inch. The strands may have a circular cross-section, but may alternatively have other cross-sectional geometries such as elliptical, rectangular as in ribbon-like strands, triangular, multi-lobal, etc. The diameter of the strands (the widest cross-sectional dimension) may vary as desired, such as within a range of from 0.1 to about 4 millimeters, in some embodiments from about 0.2 to about 2.5 millimeters, and in some embodiments, from 0.5 to about 2 millimeters. Further, the strands may generally be arranged in any direction or pattern. For example, in one embodiment, the strands are arranged in a direction that is substantially parallel to the machine direction and are desirably spaced apart from each other across the cross machine direction at similar intervals. The strands may be substantially continuous in length so that they are in the form of filaments. Such filaments may be produced using any of a variety of known techniques, such as by melt extruding a polymer from a die having a series of extrusion capillaries arranged in a row. As is well known in the art, meltblown dies may be suitable for forming the filaments, except that the high velocity gas streams used in fiber attenuation are generally not employed. Rather, the molten polymer extrudate is pumped from the die capillaries and allowed to extend away from the die under the impetus of gravity.

If desired, a layer of the aforementioned strands may also be laminated to an additional layer (e.g., meltblown web) to help secure the strands to the nonwoven web facing so that they are less likely to loosen during use. Examples of such laminates are described in more detail, for instance, in U.S. Pat. No. 5,385,775 to Wright and U.S. Patent Application Publication No. 2005/0170729 to Stadelman, et al., which are incorporated herein in their entirety by reference thereto for all purposes. In one embodiment, the strands contain the block copolymer of the present invention and the meltblown web contains a polyolefin.

In one embodiment, a thermoplastic elastomer may be employed to improve the elastic performance of the resulting elastic laminate. Any of a variety of thermoplastic elastomers may generally be employed, such as elastomeric polyesters, elastomeric polyurethanes, elastomeric polyamides, elastomeric copolymers, and so forth. For example, the thermoplastic elastomer may be a block copolymer having blocks of a monoalkenyl arene polymer separated by a block of a conjugated diene polymer. Such block copolymers generally have a relatively high viscosity and are elastic in nature. Particularly suitable thermoplastic elastomers are available from Kraton Polymers LLC of Houston, Tex. under the trade name KRATON®. KRATON® polymers include styrene-diene block copolymers, such as styrene-butadiene, styrene-isoprene, styrene-butadiene-styrene, and styrene-isoprene-styrene. KRATON® polymers also include styrene-olefin block copolymers formed by selective hydrogenation of styrene-diene block copolymers. Examples of such styrene-olefin block copolymers include styrene-(ethylene-butylene), styrene-(ethylene-propylene), styrene-(ethylene-butylene)-styrene, styrene-(ethylene-propylene)-styrene, styrene-(ethylene-butylene)-styrene-(ethylene-butylene), styrene-(ethylene-propylene)-styrene-(ethylene-propylene), and styrene-ethylene-(ethylene-propylene)-styrene. Specific KRATON® block copolymers include those sold under the brand names G 1652, G 1657, G 1730, MD6673, and MD6973. Various suitable styrenic block copolymers are described in U.S. Pat. Nos. 4,663,220, 4,323,534, 4,834,738, 5,093,422 and 5,304,599, which are hereby incorporated in their entirety by reference thereto for all purposes. Other commercially available block copolymers include the S-EP-S elastomeric copolymers available from Kuraray Company, Ltd. of Okayama, Japan, under the trade designation SEPTON®. Still other suitable copolymers include the S—I—S and S—B—S elastomeric copolymers available from Dexco Polymers, LP of Houston, Tex. under the trade designation VECTOR™. Also suitable are polymers composed of an A-B-A-B tetrablock copolymer, such as discussed in U.S. Pat. No. 5,332,613 to Taylor, et al., which is incorporated herein in its entirety by reference thereto for all purposes. An example of such a tetrablock copolymer is a styrene-poly(ethylene-propylene)-styrene-poly(ethylene-propylene) (“S-EP-S-EP”) block copolymer.

Other exemplary thermoplastic elastomers that may be used include polyurethane elastomeric materials such as, for example, those available under the trademark ESTANE from Noveon, polyamide elastomeric materials such as, for example, those available under the trademark PEBAX (polyether amide) from Atofina Chemicals Inc., of Philadelphia, Pa., and polyester elastomeric materials such as, for example, those available under the trade designation HYTREL from E.I. DuPont De Nemours & Company.

Furthermore, the elastic material may also contain a polyolefin, such as polyethylene, polypropylene, blends and copolymers thereof. In one particular embodiment, a polyethylene is employed that is a copolymer of ethylene or propylene and an α-olefin, such as a C₃-C₂₀ α-olefin or C₃-C₁₂ α-olefin. Suitable α-olefins may be linear or branched (e.g., one or more C₁-C₃ alkyl branches, or an aryl group). Specific examples include 1-butene; 3-methyl-1-butene; 3,3-dimethyl-1-butene; 1-pentene; 1-pentene with one or more methyl, ethyl or propyl substituents; 1-hexene with one or more methyl, ethyl or propyl substituents; 1-heptene with one or more methyl, ethyl or propyl substituents; 1-octene with one or more methyl, ethyl or propyl substituents; 1-nonene with one or more methyl, ethyl or propyl substituents; ethyl, methyl or dimethyl-substituted 1-decene; 1-dodecene; and styrene. Particularly desired α-olefin comonomers are 1-butene, 1-hexene and 1-octene. The ethylene or propylene content of such copolymers may be from about 60 mole % to about 99 mole %, in some embodiments from about 80 mole % to about 98.5 mole %, and in some embodiments, from about 87 mole % to about 97.5 mole %. The α-olefin content may likewise range from about 1 mole % to about 40 mole %, in some embodiments from about 1.5 mole % to about 15 mole %, and in some embodiments, from about 2.5 mole % to about 13 mole %.

The density of a linear olefin copolymer is a function of both the length and amount of the α-olefin. That is, the greater the length of the α-olefin and the greater the amount of α-olefin present, the lower the density of the copolymer. Although not necessarily required, linear “plastomers” are particularly desirable in that the content of α-olefin short chain branching content is such that the copolymer exhibits both plastic and elastomeric characteristics—i.e., a “plastomer.” Because polymerization with α-olefin comonomers decreases crystallinity and density, the resulting plastomer normally has a density lower than that of thermoplastic polymers (e.g., LLDPE), but approaching and/or overlapping that of an elastomer. For example, the density of the plastomer may be about 0.91 grams per cubic centimeter (g/cm³) or less, in some embodiments from about 0.85 to about 0.89 g/cm³, and in some embodiments, from about 0.85 g/cm³ to about 0.88 g/cm³. Despite having a density similar to elastomers, plastomers generally exhibit a higher degree of crystallinity, are relatively non-tacky, and may be formed into pellets that are non-adhesive and relatively free flowing.

Any of a variety of known techniques may generally be employed to form such polyolefins. For instance, olefin polymers may be formed using a free radical or a coordination catalyst (e.g., Ziegler-Natta). Preferably, the olefin polymer is formed from a single-site coordination catalyst, such as a metallocene catalyst. Such a catalyst system produces ethylene copolymers in which the comonomer is randomly distributed within a molecular chain and uniformly distributed across the different molecular weight fractions. Metallocene-catalyzed polyolefins are described, for instance, in U.S. Pat. Nos. 5,571,619 to McAlpin et al.; 5,322,728 to Davis et al.; 5,472,775 to Obineski et al.; 5,272,236 to Lai et al.; and 6,090,325 to Wheat, et al., which are incorporated herein in their entirety by reference thereto for all purposes.

Particularly suitable plastomers for use in the present invention may include ethylene-based copolymer plastomers available under the EXACT™ from ExxonMobil Chemical Company of Houston, Tex. Other suitable polyethylene plastomers are available under the designation ENGAGE™ and AFFINITY™ from Dow Chemical Company of Midland, Mich. Still other suitable ethylene polymers are available from The Dow Chemical Company under the designations DOWLEX™ (LLDPE) and ATTANE™ (ULDPE). Other suitable ethylene polymers are described in U.S. Pat. Nos. 4,937,299 to Ewen et al.; 5,218,071 to Tsutsui et al.; 5,272,236 to Lai, et al.; and 5,278,272 to Lai, et al., which are incorporated herein in their entirety by reference thereto for all purposes. Suitable propylene-based plastomers are likewise commercially available under the designations VISTAMAXX™ from ExxonMobil Chemical Co. of Houston, Tex.; FINA™ (e.g., 8573) from Atofina Chemicals of Feluy, Belgium; TAFMER™ available from Mitsui Petrochemical Industries; and VERSIFY™ available from Dow Chemical Co. of Midland, Mich. Other examples of suitable propylene polymers are described in U.S. Pat. No. 6,500,563 to Datta, et al.; U.S. Pat. No. 5,539,056 to Yang, et al.; and U.S. Pat. No. 5,596,052 to Resconi, et al., which are incorporated herein in their entirety by reference thereto for all purposes.

Besides polymers, the elastic material of the present invention may also contain other components as is known in the art. In one embodiment, for example, the film contains a filler. Fillers are particulates or other forms of material that may be added to the film polymer extrusion blend and that will not chemically interfere with the extruded film, but which may be uniformly dispersed throughout the film. Fillers may serve a variety of purposes, including enhancing film opacity and/or breathability (i.e., vapor-permeable and substantially liquid-impermeable). For instance, filled films may be made breathable by stretching, which causes the polymer to break away from the filler and create microporous passageways. Breathable microporous elastic films are described, for example, in U.S. Pat. Nos. 5,997,981; 6,015,764; and 6,111,163 to McCormack, et al.; 5,932,497 to Morman, et al.; 6,461,457 to Taylor, et al., which are incorporated herein in their entirety by reference thereto for all purposes.

The fillers may have a spherical or non-spherical shape with average particle sizes in the range of from about 0.1 to about 7 microns. Examples of suitable fillers include, but are not limited to, calcium carbonate, various kinds of clay, silica, alumina, barium carbonate, sodium carbonate, magnesium carbonate, talc, barium sulfate, magnesium sulfate, aluminum sulfate, titanium dioxide, zeolites, cellulose-type powders, kaolin, mica, carbon, calcium oxide, magnesium oxide, aluminum hydroxide, pulp powder, wood powder, cellulose derivatives, chitin and chitin derivatives. A suitable coating, such as stearic acid, may also be applied to the filler particles if desired. When utilized, the filler content may vary, such as from about 25 wt. % to about 75 wt. %, in some embodiments, from about 30 wt. % to about 70 wt. %, and in some embodiments, from about 40 wt. % to about 60 wt. % of the film.

Other additives may also be incorporated into the elastic material, such as crosslinking catalysts, pro-rad additives, melt stabilizers, processing stabilizers, heat stabilizers, light stabilizers, antioxidants, heat aging stabilizers, whitening agents, antiblocking agents, bonding agents, tackifiers, viscosity modifiers, etc. Suitable crosslinking catalysts, for instance, may include organic bases, carboxylic acids, and organometallic compounds, such as organic titanates and complexes or carboxylates of lead, cobalt, iron, nickel, zinc and tin (e.g., dibutyltindilaurate, dioctyltinmaleate, dibutyltindiacetate, dibutyltindioctoate, stannous acetate, stannous octoate, lead naphthenate, zinc caprylate, cobalt naphthenate; etc.). Suitable pro-rad additives may likewise include azo compounds, organic peroxides and polyfunctional vinyl or allyl compounds such as, triallyl cyanurate, triallyl isocyanurate, pentaerthritol tetramethacrylate, glutaraldehyde, polyester acrylate oligomers (e.g., available from Sartomer under the designation CN2303), ethylene glycol dimethacrylate, diallyl maleate, dipropargyl maleate, dipropargyl monoallyl cyanurate, dicumyl peroxide, di-tert-butyl peroxide, t-butyl perbenzoate, benzoyl peroxide, cumene hydroperoxide, t-butyl peroctoate, methyl ethyl ketone peroxide, 2,5-dimethyl-2,5-di(t-butyl peroxy)hexane, lauryl peroxide, tert-butyl peracetate, azobisisobutyl nitrite, etc.

Examples of suitable tackifiers may include, for instance, hydrogenated hydrocarbon resins. REGALREZ™ hydrocarbon resins are examples of such hydrogenated hydrocarbon resins, and are available from Eastman Chemical. Other tackifiers are available from ExxonMobil under the ESCOREZ™ designation. Viscosity modifiers may also be employed, such as polyethylene wax (e.g., EPOLENE™ C-10 from Eastman Chemical). Phosphite stabilizers (e.g., IRGAFOS available from Ciba Specialty Chemicals of Terrytown, N.Y. and DOVERPHOS available from Dover Chemical Corp. of Dover, Ohio) are exemplary melt stabilizers. In addition, hindered amine stabilizers (e.g., CHIMASSORB available from Ciba Specialty Chemicals) are exemplary heat and light stabilizers. Further, hindered phenols are commonly used as an antioxidant in the production of films. Some suitable hindered phenols include those available from Ciba Specialty Chemicals of under the trade name “Irganox®”, such as Irganox® 1076, 1010, or E 201. Moreover, bonding agents may also be added to the film to facilitate bonding to additional materials (e.g., nonwoven web). When employed, such additives (e.g., tackifier, antioxidant, stabilizer, crosslinking agents, pro-rad additives, etc.) may each be present in an amount from about 0.001 wt. % to about 25 wt. %, in some embodiments, from about 0.005 wt. % to about 20 wt. %, and in some embodiments, from 0.01 wt. % to about 15 wt. % of the elastic material.

Any of a variety of techniques may be employed to laminate the nonwoven web facing and the elastic material together, including adhesive bonding; thermal bonding; ultrasonic bonding; microwave bonding; extrusion coating; and so forth. For instance, adhesives may be employed to adhere the nonwoven web facing to the elastic material. Suitable adhesives include Rextac 2730 and 2723 available from Huntsman Polymers of Houston, Tex., as well as adhesives available from Bostik Findley, Inc, of Wauwatosa, Wis. The type and basis weight of the adhesive used will be determined on the elastic attributes desired in the final composite and end use. For instance, the basis weight of the adhesive may be from about 1.0 to about 3.0 gsm. The adhesive may be applied to the nonwoven web facings and/or the elastic material prior to lamination using any known technique, such as slot or melt spray adhesive systems. During lamination, the elastic material may in a stretched or relaxed condition depending on the desired properties of the resulting composite.

The nonwoven web facing may be necked in one or more directions prior to lamination to the film of the present invention. Suitable necking techniques are described in U.S. Pat. Nos. 5,336,545, 5,226,992, 4,981,747 and 4,965,122 to Morman, as well as U.S. Patent Application Publication No. 2004/0121687 to Morman, et al. Alternatively, the nonwoven web may remain relatively inextensible in a direction prior to lamination to the film.

### EXAMPLES

### Example 1

1.5 g of polyethylene oxide (PEO, Aldrich, Mv=300,000) was dissolved in an aqueous solution of acetyl tetrapeptide (0.1% by weight). The aqueous solution of acetyl tetrapeptide is commercially available under the name Eyeseryl® from Lipotec, Inc. (distributed by Centerchem Inc., Norwalk, Conn.). The solution was shaken on an Eberbach shaker until the solution was homogeneous and the PEO was dissolved. The solution was placed in a single-jet electrospinning unit and electrospun onto a 0.4 osy polypropylene spunbond fabric at 30 kV and a tip-to-target distance of 24 cm. The configuration of the electrospinning unit is shown in FIG. 2. Mass throughput was calculated by spinning onto a foil target and found to 1.495 mg/min. The spunbond facings were placed in front of the target plate for 30, 60, 90 and 120 seconds. Based on the area of deposition (113.1 cm²) basis weights of addition of nanofibers to the substrates was calculated as 0.066, 0.132, 0.198, 0.264 grams per square meter (gsm), respectively. The nanofibers for each sample were characterized by SEM and found to be virtually identical. An average diameter of 320 nm was obtained with a fiber size distribution of 80 to 560 nm. The webs were further analyzed for active Eyeseryl® via HPLC. In all cases, active peptide was found and no degradation peaks were noted. At a nanofiber coat weight of 0.066 gsm, 0.056 mg/cm² of the peptide was found, corresponding to 95% of the expected value. At higher add-on, deviation from expected values were found and are due to either retention of the peptide by the spunbond facing or errors in calculation of the nanofiber coat weight, since no degradation peaks for the Eyeseryl® were found. Inspection of the spunbond webs after extraction via optical microscopy did not indicate the presence of nanofibers, indicating that there are significant deviations from targeted treatment/coat weight due to charging effects which retard deposition at longer deposition times on the stationary web.

### Example 2

1.92 g of polyethylene oxide (PEO, Aldrich, Mv=300,000 g/mol) and 1.92 g of glycerin (Sigma G2289) were dissolved in 15.36 g of deionized water. The solution was shaken on an Eberbach shaker until the solution was homogeneous and the PEO was dissolved. The solution was placed in a single-jet electrospinning unit and electrospun onto a 0.4 osy polypropylene spunbond fabric at 30 kV (positive polarity solution with a grounded target plate) and a tip-to-target distance of 24 cm. The configuration of the electrospinning unit is shown in FIG. 2. Mass throughput was calculated by spinning onto a foil target and found to be 2.4 mg/min. SB facings were placed in front of the target plate for 30, 60, 90 and 120 seconds. Based on the area of deposition basis weights of addition of nanofibers to the substrates were calculated as 0.9, 1.6, 1.6, 2.0 grams per square meter (gsm), respectively. The nanofibers for each sample were characterized by field emission SEM. A bimodal distribution of fibers were observed with average diameters of 200 nm and 700 nm were obtained with a fiber size distribution of 40 to 360 nm and 440 nm to 1.01 μm.

### Example 3

1.92 g of polyethylene oxide (PEO, Aldrich, Mv=300,000 g/mol) and 0.28 g of AH-Care L-65 (Cognis) were dissolved in 17.00 g of deionized water. The solution was shaken on an Eberbach shaker until the solution was homogeneous and the PEO was dissolved. The solution was placed in a single-jet electrospinning unit and electrospun onto a 0.4 osy polypropylene spunbond fabric at 30 kV (positive polarity solution with a grounded target plate) and a tip-to-target distance of 24 cm. The configuration of the electrospinning unit is shown in FIG. 2. Mass throughput was calculated by spinning onto a foil target and found to be 2.8 mg/min. Spunbond facings were placed in front of the target plate for 30, 60, 90 and 120 seconds. Based on the area of deposition basis weights of addition of nanofibers to the substrates were calculated as 0.8, 0.4, 2.1, 1.1 grams per square meter (gsm), respectively. The nanofibers for each sample were characterized by field emission SEM. An average diameter of 390 nm was obtained with a fiber size distribution of 120 to 690 nm.

### Example 4

1.92 g of polyethylene oxide (PEO, Aldrich, Mv=300,000 g/mol) and 0.38 g of ABIL 350 (Degussa) were dissolved in 16.90 g of deionized water. The solution was shaken on an Eberbach shaker until the solution was homogeneous and the PEO was dissolved. The solution was placed in a single-jet electrospinning unit and electrospun onto a 0.4 osy polypropylene spunbond fabric at 30 kV (positive polarity solution with a grounded target plate) and a tip-to-target distance of 28 cm. The configuration of the electrospinning unit is shown in FIG. 2. Mass throughput was calculated by spinning onto a foil target and found to be 2.4 mg/min. Spunbond facings were placed in front of the target plate for 30, 60, 90 and 120 seconds. Based on the area of deposition basis weights of addition of nanofibers to the substrates were calculated as 0.2, 1.1, 0.7, 0.5 grams per square meter (gsm), respectively. The nanofibers for each sample were characterized by field emission SEM. An average diameter of 780 nm was obtained with a fiber size distribution of 520 to 900 nm.

### Example 5

1.92 g of polyethylene oxide (PEO, Aldrich, Mv=300,000 g/mol) and 0.19 g of a-bisabolol, natural (BASF) were dissolved in 17.09 g of deionized water. The solution was shaken on an Eberbach shaker until the solution was homogeneous and the PEO was dissolved. The solution was placed in a single-jet electrospinning unit and electrospun onto a 0.4 osy polypropylene spunbond fabric at 30 kV (positive polarity solution with a grounded target plate) and a tip-to-target distance of 28 cm. The configuration of the electrospinning unit is shown in FIG. 2. Mass throughput was calculated by spinning onto a foil target and found to be 0.9 mg/min. Spunbond facings were placed in front of the target plate for 30, 60, 90 and 120 seconds. Based on the area of deposition basis weights of addition of nanofibers to the substrates were calculated as 0.2, 1.1, 0.7, 0.5 grams per square meter (gsm), respectively. The nanofibers for each sample were characterized by field emission SEM. An average diameter of 780 nm was obtained with a fiber size distribution of 550 to 1.10 μm.

### Example 6

24.8 g of poly(vinyl alcohol), PVOH (Aldrich catalog #363081, Mw=85,000-146,000 g/mol, 87-89% hydrolyzed) and 3.15 g of lactic acid (AH Care L-65, Cognis) were dissolved in 182.0 g of deionized water. The solution was shaken on an Eberbach shaker until the solution was homogeneous and the PVOH was dissolved. The solution was placed in a Nanospider NS-200S electrospinning lab unit (Elmarco, Liberec, Czech Republic) which employs a cylindrical electrode (see international publication number WO2005/024101, which is hereby incorporated by reference, for a description of a cylindrical electrode) and electrospun onto a 0.9 osy bonded carded web fabric (75% 3.0 denier FiberVisions ESC 215 bicomponent PE sheath/PP core fiber with 0.55% HR6 finish, 25% 6.0 denier Invista T-295 polyester fiber with 0.50% L1 finish) at 65.7 kV (or 4.87 kV/cm calculated by dividing the voltage applied by the distance between electrodes) and a cylindrical electrode to ground distance of 13.5 cm. Atmospheric conditions were 56% relative humidity and 70° F. Average mass throughput was calculated to be 0.17 g/min. The average basis weight was 0.6 gsm. The nanofibers for each sample were characterized by field emission SEM. An average fiber diameter of 240 nm was obtained with a fiber size distribution ranging from 110 to 650 nm.

### Example 7

24.7 g of poly(vinyl alcohol), PVOH (Aldrich catalog #363081, Mw=85,000-146,000 g/mol, 87-89% hydrolyzed) and 4.0 g of polydimethylsiloxane (ABIL 350, Degussa) were dissolved in 181.2 g of deionized water. The solution was shaken on an Eberbach shaker until the solution was homogeneous and the PVOH was dissolved. The solution was placed in the Elmarco Nanospider electrospinning lab unit described in Example 6 and electrospun onto a 0.9 osy bonded carded web fabric (75% 3.0 denier FiberVisions ESC 215 bicomponent PE sheath/PP core fiber with 0.55% HR6 finish, 25% 6.0 denier Invista T-295 polyester fiber with 0.50% L1 finish) at 75.7 kV and a cylindrical electrode to ground distance of 11.0 cm, or 6.9 kV/cm. Atmospheric conditions were 44% relative humidity and 72° F. Average mass throughput was calculated to be 0.29 g/min. The basis weight of the nanofiber layer was calculated gravimetrically to be 1.05 gsm. The nanofibers for each sample were characterized by field emission SEM. An average fiber diameter of 310 nm was obtained with a fiber size distribution ranging from 120 to 820 nm.

### Example 8

24.7 g of poly(vinyl alcohol), PVOH (Aldrich catalog #363081, Mw=85,000-146,000 g/mol, 87-89% hydrolyzed) and 4.0 g of sodium ascorbyl phosphate (BASF) were dissolved in 181.2 g of deionized water. The solution was shaken on an Eberbach shaker until the solution was homogeneous and the PVOH was dissolved. The solution was placed in the Elmarco Nanospider electrospinning lab unit described in Example 6 and electrospun onto a 0.9 osy bonded carded web fabric (75% 3.0 denier FiberVisions ESC 215 bicomponent PE sheath/PP core fiber with 0.55% HR6 finish, 25% 6.0 denier Invista T-295 polyester fiber with 0.50% L1 finish) at 75.5 kV and a cylindrical electrode to ground distance of 10.0 cm, or 7.5 kV/cm. Atmospheric conditions were 49% relative humidity and 68° F. Average mass throughput was calculated to be 0.38 g/min. The basis weight of the nanofiber layer was calculated gravimetrically to be 1.6 gsm. The nanofibers for each sample were characterized by field emission SEM. An average fiber diameter of 230 nm was obtained with a fiber size distribution ranging from 70 to 630 nm.

### Example 9

24.7 g of poly(vinyl alcohol), PVOH (Aldrich catalog #363081, Mw=85,000-146,000 g/mol, 87-89% hydrolyzed) and 2.0 g of α-bisabolol, natural (BASF) were dissolved in 181.2 g of deionized water. The solution was shaken on an Eberbach shaker until the solution was homogeneous and the PVOH was dissolved. The solution was placed in the Elmarco Nanospider electrospinning lab unit described in Example 6 and electrospun onto a 0.9 osy bonded carded web fabric (75% 3.0 denier FiberVisions ESC 215 bicomponent PE sheath/PP core fiber with 0.55% HR6 finish, 25% 6.0 denier Invista T-295 polyester fiber with 0.50% L1 finish) at 70.4 kV and a cylindrical electrode to ground distance of 13.5 cm (5.2 kV/cm calculated by dividing the voltage applied by the distance between electrodes). Atmospheric conditions were 53% relative humidity and 71° F. Average mass throughput was calculated to be 0.14 g/min. The basis weight of the nanofiber layer was calculated gravimetrically to be 0.5 gsm. The nanofibers for each sample were characterized by field emission SEM. An average fiber diameter of 250 nm was obtained with a fiber size distribution ranging from 60 to 1.18 μm.

While the invention has been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A method for forming a composite nonwoven web configured to deliver skin wellness agents, the method comprising:
forming an aqueous system of a hydrophilic polymer and a skin wellness agent; and
electrospinning nanofibers from the aqueous system onto a surface of a nonwoven web comprising synthetic fibers, wherein the nanofibers have an average diameter of from about 50 nanometers to about 5000 nanometers.

2. The method according to claim 1, wherein the hydrophilic polymer comprises a hydrophilic polyether.

3. The method according to claim 1, wherein the hydrophilic polymer comprises a polyalkylene oxide.

4. The method according to claim 3, wherein the polyalkylene oxide has an average molecular weight of about 100,000 g/mol to about 600,000 g/mol.

5. The method according to claim 3, wherein the polyalkylene oxide has an average molecular weight of about 200,000 g/mol to about 500,000 g/mol.

6. The method according to claim 1, wherein the hydrophilic polymer comprises a polyvinyl alcohol.

7. The method according to claim 6, wherein the polyvinyl alcohol is hydrolyzed in an amount of about 80 mole % to about 95 mole %.

8. The method according to claim 1, wherein the skin wellness agent is dispersed, suspended, or emulsified in the aqueous system.

9. The method according to claim 1, wherein the skin wellness agent is soluble in the aqueous system.

10. The method according to claim 1, wherein the nanofibers have an average diameter of from about 200 nanometers to about 700 nanometers.

11. The method according to claim 1, wherein the aqueous system further comprises a solvent system comprising water, acetic acid, acetone, acetonitrile, alcohol, alkyl acetate, polyethylene glycol, propylene glycol, methyl ethyl ketone, or mixtures thereof.

12. The method according to claim 1, wherein the synthetic fibers of the nonwoven web are multicomponent synthetic fibers.

13. The method according to claim 1, wherein the nonwoven web is laminated to an elastic component on a second surface opposite of the surface containing the electrospun nanofibers.

14. A method for forming a composite nonwoven web configured to deliver skin wellness agents, the method comprising:
forming an aqueous system of a hydrophilic polymer and a skin wellness agent, wherein the hydrophilic polymer is a polyalkylene oxide or a polyvinyl alcohol; and
electrospinning nanofibers from the aqueous system onto a surface of a nonwoven web comprising synthetic fibers, wherein the aqueous system is electrospun between the temperatures of about 20° C. and about 25° C., wherein the nanofibers have an average diameter of from about 50 nanometers to about 5000 nanometers.

15. The method according to claim 14, wherein the hydrophilic polymer comprises a polyalkylene oxide having an average molecular weight of about 100,000 g/mol to about 600,000 g/mol.

16. The method according to claim 14, wherein the hydrophilic polymer comprises a polyalkylene oxide having an average molecular weight of about 200,000 g/mol to about 500,000 g/mol.

17. The method according to claim 14, wherein the hydrophilic polymer comprises a fully hydrolyzed polyvinyl alcohol.

18. The method according to claim 14, wherein the hydrophilic polymer comprises a polyvinyl alcohol that is hydrolyzed in an amount of about 80 mole % to about 95 mole %.

19. The method according to claim 14, wherein the nanofibers have an average diameter of from about 200 nanometers to about 700 nanometers.

20. The method according to claim 14, wherein the synthetic fibers of the nonwoven web are multicomponent synthetic fibers.

21. The method according to claim 14, wherein the nonwoven web is laminated to an elastic component on a second surface opposite of the surface containing the electrospun nanofibers.
